(19) United States
(12) Patent Application Publication
(10) Pub. No.: US 2025/0092705 A1
(43) Pub. Date: Mar. 20, 2025

(54) SPA WATER TREATMENT SYSTEM

(71) Applicant: King Technology, Inc., Minnetonka, MN (US)

(72) Inventors: Eric Barton, Eden Prairie, MN (US); Darrin M. Swagel, Minnetonka, MN (US)

(21) Appl. No.: 18/883,832

(22) Filed: Sep. 12, 2024

Related U.S. Application Data
(60) Provisional application No. 63/583,107, filed on Sep. 15, 2023.

(51) Int. Cl. E04H 4/14; C02F 1/00; C02F 1/68; C02F 103/42

(52) U.S. Cl. CPC E04H 4/14; C02F 1/001; C02F 1/685; C02F 2103/42; C02F 2201/006; C02F 2301/046

(57) ABSTRACT

Described herein is a spa having a water treatment system. The water treatment system includes a spa shell forming a water chamber for containing spa water, a piping system external to the water chamber that provides one or more recirculating water flow paths, and one or more receptacles in an upright wall in the water chamber. One of the one or more recirculating water flow paths include a filter. The one or more recirculating water flow paths remove spa water from the water chamber and return the spa water to the water chamber. One or more dispensing cartridges removably fixed in the one or more receptacles, each having a plurality of openings for dispensing a dispersant, each dispersant providing a water treatment function. The plurality of openings are below a water line of the water chamber and in fluid communication with spa water when the water chamber holds spa water.

### CROSS REFERENCE TO RELATED APPLICATION

This application claims the benefit of U.S. Provisional Application No. 63/583,107, filed Sep. 15, 2023, the content of which is hereby incorporated by reference in its entirety.

### TECHNICAL FIELD

The invention relates to a spa water treatment system that includes a cartridge holder that receives dispensing cartridges that dispenses a dispersant in water of a spa. The invention also relates to a spa having a water treatment system.

### BACKGROUND

Spas typically have a water filtration system. Water flows through a recirculating water flow path from a main seating area in a spa shell, through a filter, and then back to the main seating area. The filter removes contaminants such as debris and bacteria from the water before it returns to the main seating area. The filter is often located in a location outside of the main seating area of the spa so as to not interfere with persons in the main seating area. The recirculating water flow path can be provided inside an internal piping system that is outside the water chamber. Generally, water in the recirculating water flow path has more turbulence than stagnant water, so as to actively move the water through the water system. The filter is also often directly in line with a recirculating water flow path to ensure that all water gets filtered.

Spas also have dispensing cartridges that dispense dispersants into the water to treat it. Dispensing cartridges are often placed within the recirculating water flow path through the filter to ensure that the dispensing cartridges also do not interfere with persons in the main seating area. One drawback to this approach is that water in the water flow path moves at an accelerated velocity and includes turbulence and swirling, which causes dispensing cartridges to dispense dispersants into the water more rapidly than desired. This leads to the need to replace depleted dispensing cartridges more often than desired and can be costly to a spa owner.

It would be desirable to provide a water treatment system that allows a portion of a dispensing cartridge to be in fluid communication with water while also ensuring that dispersants are not rapidly depleted. It would also be desirable to provide a water treatment system that allows a portion of a dispensing cartridge to be in fluid communication with water in the main seating area. It would further be desirable to provide a water treatment system that allows a portion of a dispensing cartridge to be surrounded by a water pocket that is not in fluid communication with a recirculating water flow path. It would also be desirable to provide a water treatment system that allows dispensing cartridges to be easily removable and replaceable. Even further, it would be desirable to provide a spa having a water treatment system having these desired features.

### BRIEF DESCRIPTION OF THE DRAWINGS

FIG. 1 illustrates a front perspective view of a cartridge holder receiving two dispensing cartridges within two receptacles according to an embodiment.

FIG. 2 illustrates a bottom perspective view of a dispensing cartridge with a lid removed according to an embodiment.

FIG. 3 illustrates a side perspective view of a dispensing cartridge according to an embodiment.

FIG. 4 illustrates a bottom perspective view of a dispensing cartridge according to an embodiment.

FIG. 5 illustrates a top perspective view of a lid of a dispensing cartridge cap according to an embodiment.

FIG. 6 illustrates a top perspective view of a rotatable disc of a dispensing cartridge cap according to an embodiment.

FIG. 7 illustrates a bottom perspective view of a lid of a dispensing cartridge cap according to an embodiment.

FIG. 8 illustrates a bottom perspective view of a rotatable disc of a dispensing cartridge cap according to an embodiment.

FIG. 9 illustrates a front perspective view of a filter housing including a cartridge holder according to an embodiment.

FIG. 10A illustrates a front view of a cartridge holder with two receptacles according to an embodiment.

FIG. 10B illustrates a front view of a cartridge holder receiving two dispensing cartridges within two receptacles according to an embodiment.

FIG. 11 illustrates a side cutout section view of a cartridge holder receiving a dispensing cartridge according to an embodiment.

FIG. 12A illustrates a front exploded view of a filter housing according to an embodiment.

FIG. 12B illustrates a rear exploded view of a filter housing according to an embodiment.

FIG. 13A illustrates a front view of an alternative cartridge holder with two receptacles according to an embodiment.

FIG. 13B illustrates a front view of the alternative cartridge holder receiving two dispensing cartridges within two receptacles.

FIG. 14A illustrates a front exploded view of an alternative filter housing according to an embodiment.

FIG. 14B illustrates a rear exploded view of the alternative filter housing.

FIG. 15 illustrates a rear perspective view of a filter housing according to an embodiment.

FIG. 16 illustrates a front perspective view of a frame within a rear component of a filter housing according to an embodiment.

FIG. 17 illustrates a front perspective view of a filter within a frame and a frame within a rear component of a filter housing according to an embodiment.

FIG. 18 illustrates a side sectional view of a filter housing according to an embodiment.

FIG. 19 illustrates a top perspective view of a spa having an upright spa sidewall receiving two dispensing cartridges within two receptacles, the upright spa sidewall exposed to a main seating area.

FIG. 20 illustrates a top perspective view of a spa having a cartridge holder receiving two dispensing cartridges within two receptacles, the cartridge holder being received by an upright spa sidewall exposed to a main seating area.

FIG. 21 illustrates a top perspective view of a spa having a recess receiving a filter housing including a cartridge holder.

### SUMMARY

In general, the present disclosure relates to a spa water treatment system that includes a cartridge holder that receives dispensing cartridges that dispenses a dispersant in water of a spa. In a first example, a spa having a water treatment system may include a spa shell forming a water chamber for containing spa water, a piping system external to the water chamber that provides one or more recirculating water flow paths, one of the one or more recirculating water flow paths including a filter, the one or more recirculating water flow paths removing spa water from the water chamber and returning the spa water to the water chamber, and one or more receptacles in an upright wall located in the water chamber. One or more dispensing cartridges may each include plurality of openings for dispensing a dispersant, each dispersant providing a water treatment function, the one or more dispensing cartridges removably fixed in the one or more receptacles where the plurality of openings are below a water line of the water chamber and in fluid communication with spa water when the water chamber holds spa water, the plurality of openings permitting ingress and egress of spa water into and out of the one or more dispensing cartridges to aid in dispensing the dispersants into the spa water.

Additionally or alternatively, the upright wall is a spa sidewall integral to the spa shell.

Additionally or alternatively, the upright wall is in a main seating area of the spa shell.

Additionally or alternatively, the upright wall is an upright sidewall of the spa shell located behind a removable structure of the spa, the removable structure not being watertight with the upright sidewall of the spa.

Additionally or alternatively, the removable structure is a removable seat or a removable jet module.

Additionally or alternatively, the spa shell includes a plurality of sidewalls that form a main seating area, some of the plurality of sidewalls being covered by removable components, the removable components not blocking exposure of the some of the plurality of sidewalls to spa water, the one or more receptacles being covered by the removable components.

Additionally or alternatively, the spa shell includes a plurality of sidewalls that form a main seating area, some of the sidewalls being covered by removable components, seams between the some of the plurality of sidewalls and the removable components being pervious thereby exposing the some of the plurality of sidewalls to spa water, the one or more receptacles being covered by the removable components.

Additionally or alternatively, the one or more receptacles include one or more water pockets along a lower surface of the one or more receptacles below the plurality of openings, the water pockets filling with spa water with the water line above the plurality of openings, the water pockets protecting the plurality of openings from turbulent flow of spa water.

Additionally or alternatively, the one or more water pockets are not in fluid communication with the piping system providing the one or more recirculating water flow paths.

Additionally or alternatively, the one or more receptacles include one or more passages into some of the one or more recirculating water flow paths, the one or more the one or more passages permitting water flow permitting water flow between the some of the one or more recirculating water flow paths and the one or more receptacles.

Additionally or alternatively, the one or more the one or more passages permitting water to be sucked from the one or more receptacles into the some of the one or more recirculating water flow paths.

Additionally or alternatively, the one or more receptacles and the one or more dispensing cartridges are configured to create a friction fit to hold the one or more dispensing cartridges within the one or more receptacles.

Additionally or alternatively, the one or more dispensing cartridges have recesses and the one or more receptacles have protrusions, the recesses being sized and positioned to receive the protrusions in a friction fit to hold the one or more dispensing cartridges in the one or more receptacles when the one or more dispensing cartridges are located in the one or more receptacles.

Additionally or alternatively, the one or more receptacles include one or more finger pockets along an upper surface of the one or more receptacles above the one or more dispensing cartridges and being sized and shaped to allow a finger or thumb to insert into the one or more finger pockets and dislodge the dispensing cartridges.

In another example, a spa having a water treatment system may include a spa shell forming a water chamber for containing spa water, one or more receptacles in an upright wall located in the water chamber, one or more dispensing cartridges each having plurality of openings for dispensing a dispersant, each dispersant providing a water treatment function, the one or more dispensing cartridges removably fixed in the one or more receptacles where the plurality of openings are below a water line of the water chamber and in fluid communication with spa water when the water chamber holds spa water, the plurality of openings permitting ingress and egress of spa water into and out of the one or more dispensing cartridges to aid in dispensing the dispersants into the spa water, and a filter housing having a water inlet port and a water outlet port with a filter in a water flow path therebetween, the one or more receptacles being in the filter housing outside of the water flow path.

Additionally or alternatively, the filter housing is removable from the spa.

Additionally or alternatively, the water inlet port receives spa water from the water chamber and the water outlet port outputs spa water to the water chamber.

Additionally or alternatively, the water inlet port receiving spa water via an inlet or drain and the water outlet port outputting spa water to an outlet leading back to the water chamber.

Additionally or alternatively, spa water is pulled through the water outlet port via downstream pumps.

Additionally or alternatively, the flow of spa water through the filter housing is via a recirculating water flow path in a piping system external to the water chamber.

Additionally or alternatively, the filter housing is covered by removable components.

Additionally or alternatively, the one or more receptacles include one or more passages into an interior of the filter housing, the one or more passages permitting water flow between the filter housing and the one or more receptacles.

Additionally or alternatively, the one or more passages permitting water to be sucked from the one or more receptacles into the filter housing.

Additionally or alternatively, the one or more dispensing cartridges include a vent hole permitting ingress and egress of spa water into and out of the one or more dispensing cartridges to aid in dispensing the dispersants into the spa water.

Additionally or alternatively, the plurality of openings have variable numbers to adjust the rate of dispensing the dispersant.

Additionally or alternatively, the variable sizes include an off position, a maximum position, and intermediate positions therebetween.

Additionally or alternatively, the plurality of openings are formed via caps with a lid and a rotatable disc, the rotatable disc being rotatable to control the number of openings.

Additionally or alternatively, the one or more receptacles are sized and shaped to receive the one or more dispensing cartridges in upright positions with the plurality of openings facing downwards.

Additionally or alternatively, the one or more dispensing cartridges include two dispensing cartridges and the two dispensing cartridges are positioned side-by-side in the upright wall.

Additionally or alternatively, each of the one or more dispensing cartridges includes an adapter that adapts the one or more dispensing cartridges to fit within the one or more receptacles.

Additionally or alternatively, the one or more dispensing cartridges are restricted from removal from within the one or more receptacles.

The details of one or more examples are set forth in the accompanying drawings and the description below. Other features, objects, and advantages will be apparent from the description and drawings, and from the claims.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

In the present specification, anywhere the terms “comprising” or “comprises” are used, those terms have their ordinary, open-ended meaning. In addition, where appropriate, the disclosure at each such location is to be understood to also disclose that it may, as an alternative, “consist essentially of” or “consist of.”

Additionally, anywhere the term “spa” is used, this term generally refers to any water chamber or water holder having a main seating area where one or more users sit in water, such as but not limited to hot tub, bath, whirlpool, Jacuzzi and pool.

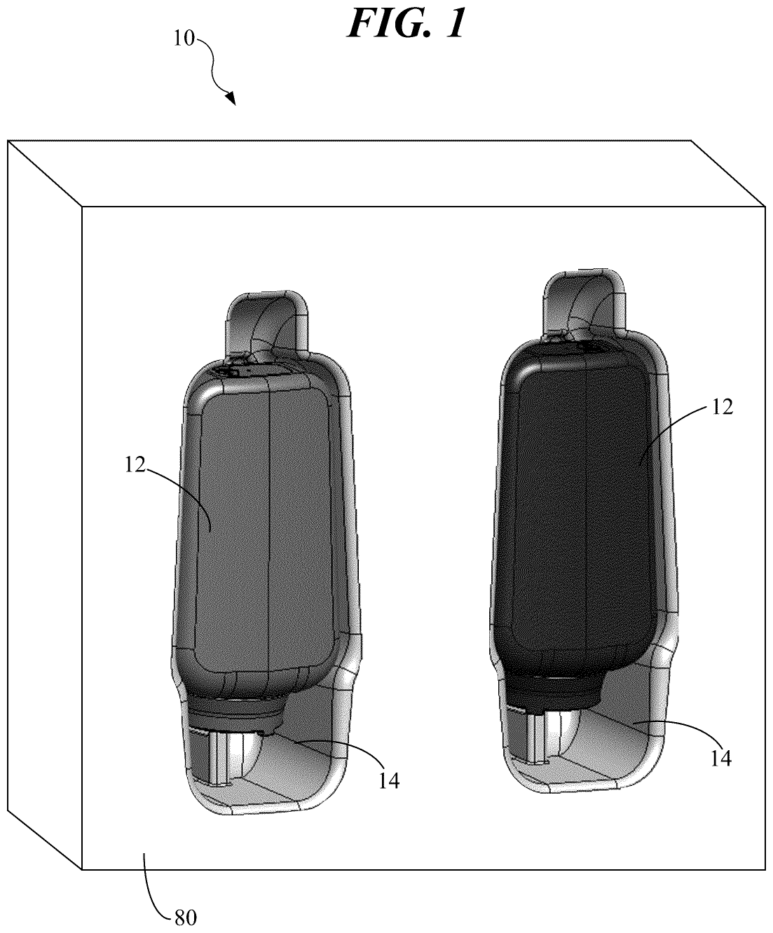

Some embodiments provide a cartridge holder 10 that holds a dispensing cartridge 12 in an upright position. Referring to FIG. 1, the cartridge holder 10 generally includes an upright sidewall 80 that includes a receptacle 14 that receives a dispensing cartridge 12. The upright sidewall 80 can be a vertical sidewall or a slanted sidewall, so long as the sidewall is in a general upright configuration.

In the illustrated embodiments, the upright sidewall 80 includes two receptacles 14 that receive two dispensing cartridges 12. Skilled artisans will understand that a single receptacle and single dispensing cartridge can also be used. Likewise, three or more receptacles and corresponding dispensing cartridges can be used.

The dispensing cartridge 12 is a replaceable cartridge that dispenses one or more dispersants into water to maintain the water. Once the dispensing cartridge is depleted of dispersant, it is removed and replaced. The dispensing cartridge 12 can be hand inserted and hand releasable from the receptacle 14.

In some cases, the cartridge holder 10 is integrated as part of a spa. For example, the cartridge holder 10 can be integral to a component of the spa, such as a spa sidewall. In other cases, the cartridge holder 10 is a separate component that engages a spa structure. For example, the cartridge holder 10 be a separate component that fits within a recess in a spa structure, such as a spa sidewall. In other cases, the cartridge holder 10 can be provided as part of a filter housing 100, which can be a separate component that engages a spa structure.

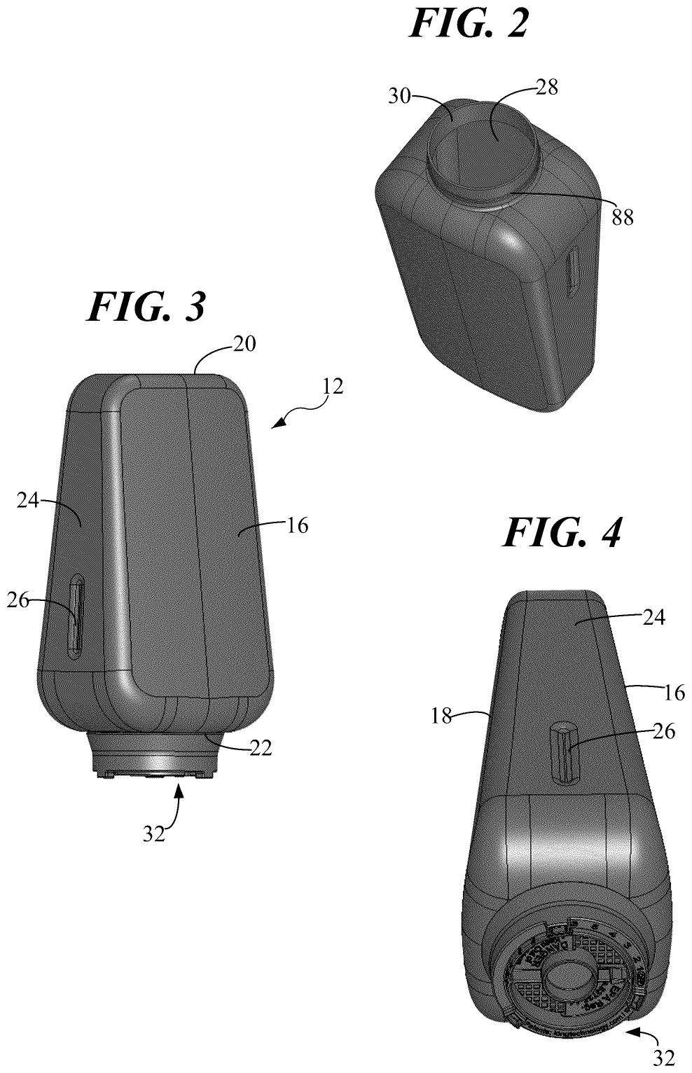

Referring to FIGS. 2-4, the dispensing cartridge 12 includes a cartridge body that defines an enclosed chamber that holds a dispersant. The dispersant can be any material used to treat water in the spa. The dispensing cartridge 12 includes a front wall 16, rear wall 18, top wall 20, a bottom wall 22 and two sidewalls 24 that form a cartridge body having a desired shape. The two sidewalls 24 each include an indentation 26. The cartridge body can be formed of any suitable material. In many cases, the cartridge body is formed of a rigid material. In many cases, the top wall 20 includes a vent hole (not shown). The vent hole allows for ingress and egress of water and gas into and out of the cartridge body.

The bottom wall 22 includes a circumferential opening 28 to the enclosed chamber. The circumferential opening 28 has a corresponding circumferential rim 30 that extends away from the bottom wall 22. In some cases, the circumferential rim 30 extends in a direction generally perpendicular to the bottom wall 22.

The dispensing cartridge 12 also includes a cap 32 that engages the rim 30 to cover the circumferential opening 28. In the illustrated case, the circumferential opening 28 has a circular shape and the circumferential rim 30 has a corresponding circular shape. In such cases, the cap 32 also can have a circular shape although this is not required. Skilled artisans will understand that a variety of other shapes can also be used.

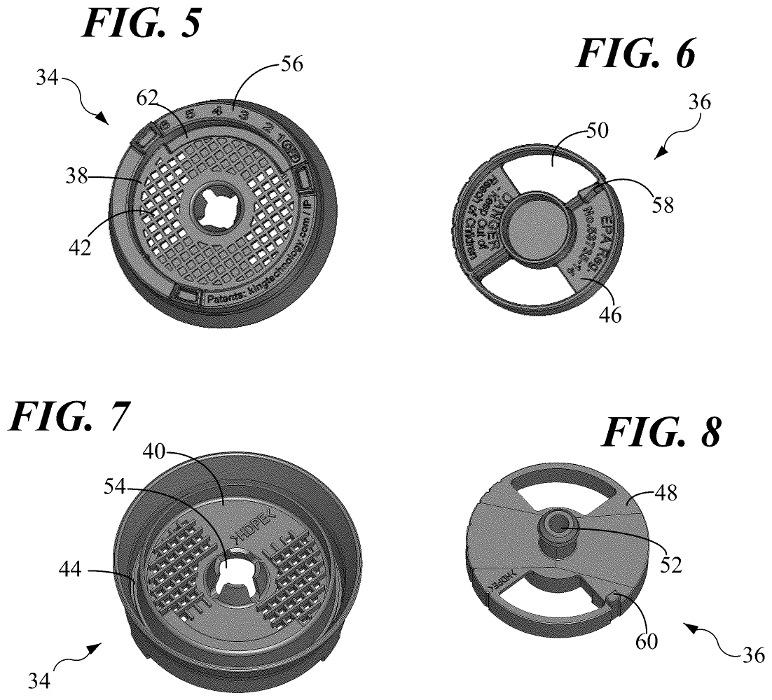

As shown in FIGS. 5-8, the cap 32 generally includes a lid 34 and a rotatable disc 36. The lid 34 includes a top surface 38 and a bottom surface 40. The lid 34 also includes a plurality of holes 42 that extend from the top surface 38 to the bottom surface 40. The plurality of holes 42 allows water to ingress and egress from the chamber, which in turn aids dispersants in moving out of the holes 42 and into surrounding water.

The lid 34 connects to the rim 30. In the illustrated embodiment, the lid 34 is spun welded to the circumferential rim 30. For example, the circumferential rim 30 can have a circumferential protrusion 88 that protrudes radially outward the perimeter of the rim 30. Also, the bottom surface 40 of the lid 34 includes a circumferential bevel 44. The circumferential rim 30 inserts into the circumferential bevel 44 and these components can be welded together or otherwise connected together. The circumferential bevel 44 can also serve as a sacrificial material in the resulting spun weld joint. Skilled artisans will understand that other suitable mechanisms of connecting the lid 34 to the circumferential rim 30 can also be used.

The rotatable disc 36 also connects to the lid 34. The rotatable disc 36 includes a top surface 46 and a bottom surface 48. The rotatable disc 36 also includes one or more cutouts 50 that extend from the top surface 46 to the bottom surface 48. The rotatable disc 36 connects to the top surface 38 of the lid 34 such that it rotates with respect to the lid 34. In the illustrated embodiment, the bottom surface 48 of the rotatable disc 36 includes a snap button 52. Likewise, the lid 34 includes a corresponding snap opening 54. The snap button 52 snaps into the snap opening 54 to connect the rotatable disc 36 to the lid 34 such that the rotatable disc 36 rotates relative to the lid 34. Skilled artisans will understand that other suitable mechanisms of connecting the rotatable disc 36 to the lid 34 such that rotatable disc 36 rotates with respect to the lid can be used.

The lid 34 also includes a scale 56 that corresponds to a relative dispensing rate of the dispersant inside the chamber. In the illustrated embodiment, the scale 56 is provided on a top surface 38 of the lid. The scale 56 includes an “off” position where no dispersants or fewer dispersants will be dispensed. The scale 56 also includes a “maximum” position (shown as “6” in the illustrated embodiment) where a maximum amount of dispersants will be dispensed at a maximum rate. Finally, the scale 56 includes positions in between the off position and the maximum position (shown as “1”, “2”, “3”, “4” and “5”) to enable one to select a relative dispensing rate. In some embodiments, positions are simply relative to one another and do not directly meter a specific dispensing rate. While specific embodiments of the scale 56 are shown and described, skilled artisans will understand that other scale configurations can be used.

The rotatable disc 36 also includes an arrow marker 58 that can align to point to the different dispensing positions on the scale 56. The cutouts 50 in the rotatable disc can also be sized relative to the plurality of openings 42 on the lid. For example, the cutouts 50 can have a size selected to expose all of the openings 42 when the arrow marker 58 points to the maximum position on the scale 56. Similarly, the cutouts 50 can expose none of the openings 42 when arrow marker 58 points to the off position. Further, the cutouts 50 can expose a portion of the openings 42 when the arrow marker 58 points to the “1” position and a larger portion of the openings 42 when the arrow marker 58 points to the “2” position and so on. The illustrated embodiment shows the cutouts 50 as having an arc shape that corresponds to an arc shaped area that includes the openings 42. However, skilled artisans will understand that a variety of different shapes can be used for the cutouts 50 and openings 42 to allow for different portions of the openings 42 to be exposed according to a scale system.

The rotatable disc 36 can also have limited rotation relative to the lid 34. In some embodiments, the bottom surface 48 of the rotatable disc 36 includes a tab 60 that slidably engages with a bevel 62 in the top surface 38 of the lid 34. The bevel 62 extends for only a portion of the top surface 38 of the lid 34 that abuts the scale 56. The tab 60 and bevel 62 allow for the disc 36 to only rotate relative to the dispensing positions on the scale 56. Such features further allow a user to carefully control dispensing rates of the dispersant.

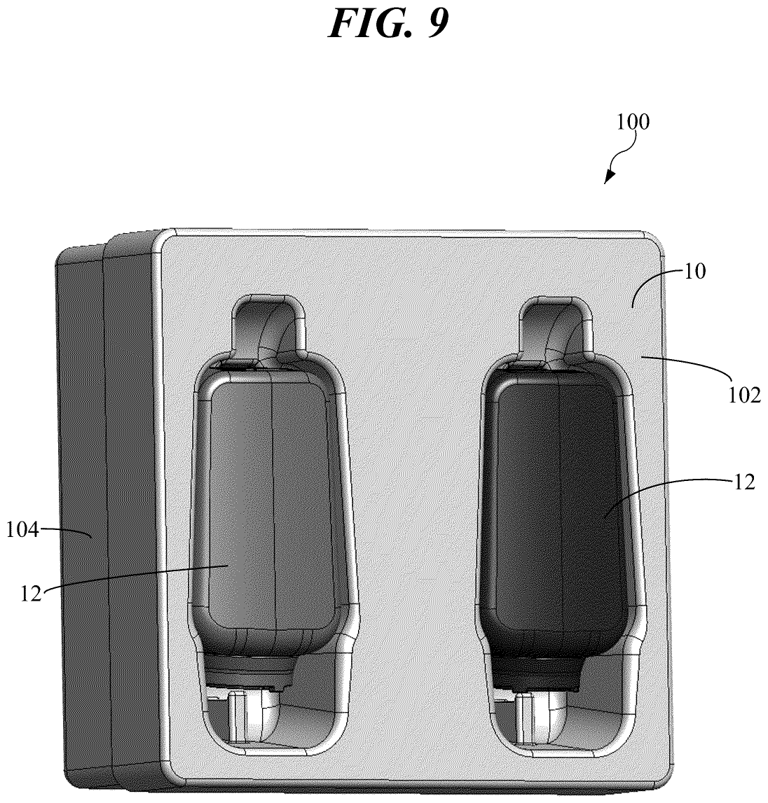

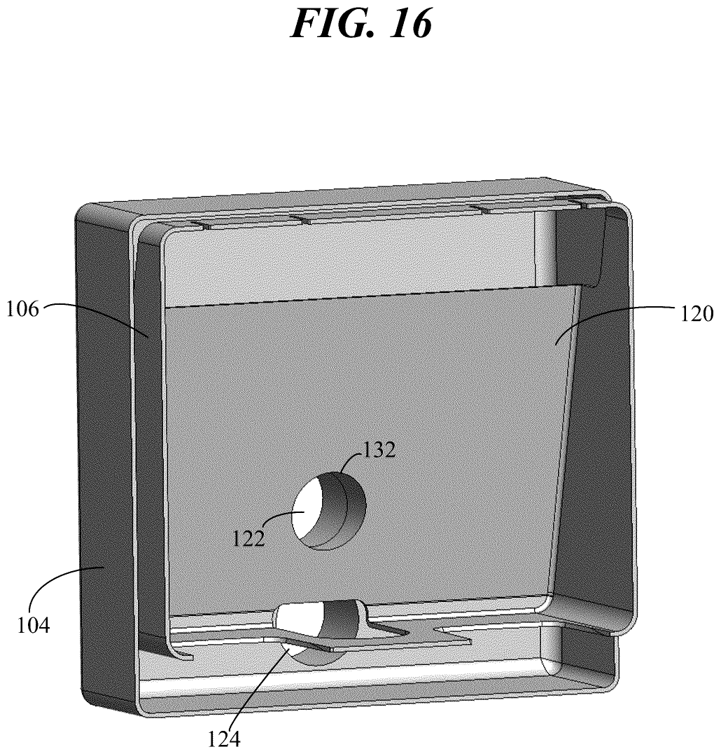

Referring the FIGS. 9-18, some embodiments provide a cartridge holder 10 as part of a filter housing 100. FIG. 9 illustrates a filter housing 100 in an assembled configuration. The filter housing 100 is provided within a spa filter line that includes a water flow path. The filter housing 100 includes a front component 102 and a rear component 104 that fit together to house a frame 106 and a filter 108. The front component 102 includes an outer surface 110 and an inner surface 112. Likewise, the rear component 104 includes an outer surface 114 and an inner surface 116. Further, the frame 106 includes an outer surface 118 and an inner surface 120. As used herein, the term “outer surface” refers to a surface any component that faces away from the filter 108 housed inside. Likewise, the term “inner surface” refers to a surface that faces the filter 108 housed inside.

As best shown in FIG. 9, the outer surface 110 of the front component 102 includes the cartridge holder 10. In other words, the cartridge holder 10 is provided as part of the outer surface 110 of the front component 102. The cartridge holder 10 can have any of the embodiments already described herein.

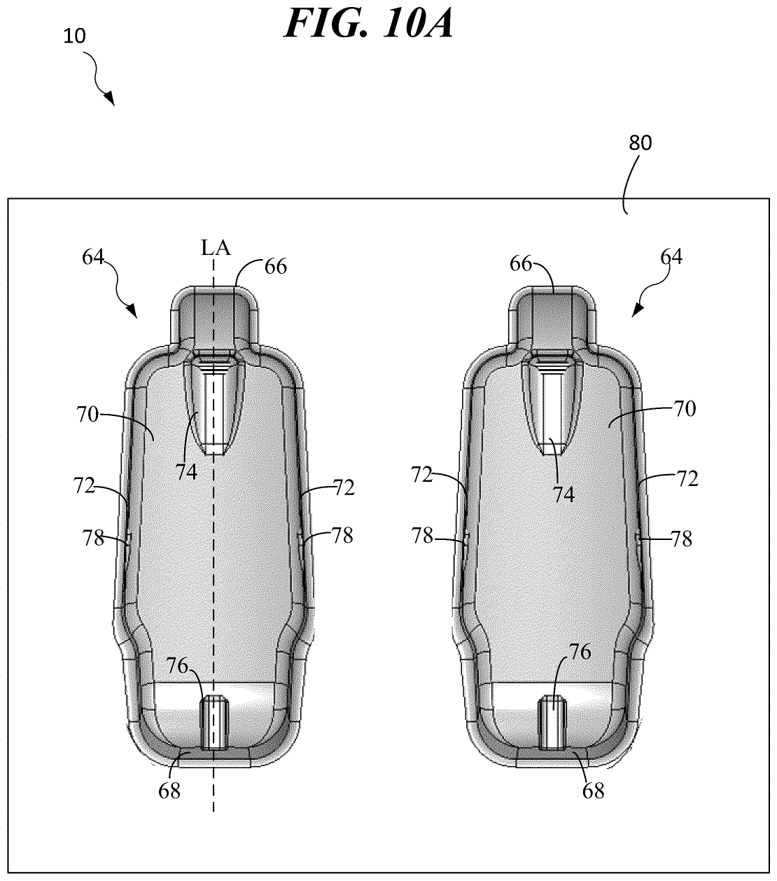

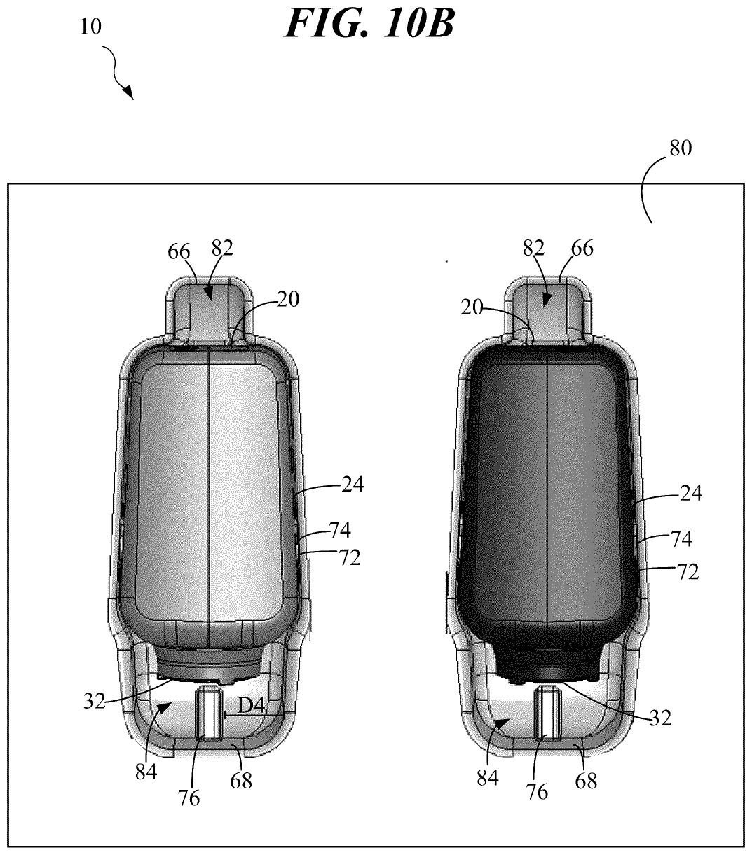

Referring to FIGS. 10A-10B, the cartridge holder 10 includes an upright sidewall 80. The upright sidewall 80 includes a receptacle 64 that is sized and shaped to receive the dispensing cartridge 12 in an upright position. In some cases, two receptacles 64 are provided that hold two dispensing cartridges 12 in a fixed side-by-side vertical position. While the illustrated embodiments illustrate the dispensing cartridges 12 as having the same shape, skilled artisans would understand that different shaped dispensing cartridges 12 can also be used. In fact, the receptacles 64 can have a size and shape configured to accommodate a variety of different cartridge shapes.

Further, the receptacle 64 is sized and shaped to hold the cartridge 12 so that the plurality of openings 42 is underneath the cartridge body. In other words, the plurality of openings 42 face downward. Such an arrangement allows for gravity to assist in moving dispersant out of the dispensing cartridge 12.

The receptacle 64 includes an upper surface 66, a bottom surface 68, a rear surface 70, and surface 72 that all form any suitable shape to receive a corresponding dispensing cartridge 12. The receptacle 64 is also open at a front. The receptacle 64 also includes a depression 74, an upstanding tab 76 and protrusions 78. The depression 74 is formed within a rear surface 70 of the receptacle. The protrusions 78 are formed within the side surfaces 72 and extend outward the side surfaces 72.

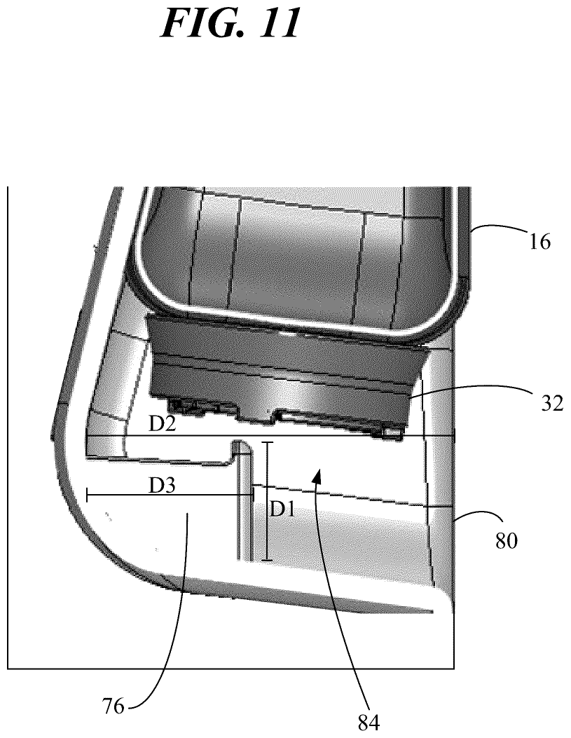

As best shown in FIG. 11, the upstanding tab 76 is formed in the bottom surface 68 and extends upward from the bottom surface 68. In some cases, the upstanding tab 76 extends upward in a direction generally perpendicular to the bottom surface 68. The upstanding tab 76 can also be formed in the rear surface 70 such that it extends forward of the rear surface 70. In some cases, the upstanding tab 76 extends forward of the rear surface 70 in a direction generally perpendicular to the rear surface 70. Also, in certain cases, the upstanding tab 76 is centered along a longitudinal axis LA of the receptacle as shown in FIG. 10A.

Further, the upstanding tab 76 extends upward from the bottom surface 68 for a distance D1. Likewise, the upstanding tab 76 extends forward from the rear surface 70 for a distance D3. The upstanding tab 76 allows for differently sized cartridges to fit into the receptacle 64 using a selected adapter.

The upstanding tab 76 may also help ensure that the plurality of openings 42 are positioned at least a distance D1 from the bottom surface 68. The distance D1 is any distance sufficient to form a water pocket between the plurality of openings 42 and the bottom surface 68 that allows water to ingress and egress for the openings 42. Further, the upstanding tab 76 extends forward for a distance D3, which is less than a distance D2 from the rear surface 70 to the front. In some cases, the upstanding tab 78 is omitted. Any suitable configuration can be used so long as a water pocket is maintained between the plurality of openings 42 and the bottom surface 68.

The protrusions 78 are sized and shaped to be received by indentations 26 on a sidewall 24 of a dispensing cartridge 12. Any kind of protrusion 78 can be provided, such as a post, a wall or a snap that can engage the indentations 26. In some cases, the protrusions 78 are configured to snap into an indentation 26 on a sidewall 24 of a dispensing cartridge 12. The protrusions 78 create a friction fit to hold the dispensing cartridge 12 in place within the receptacle 64. This allows the dispensing cartridge 12 to snap fit into the receptacle 64 so that the receptacle 64 removably receives the dispensing cartridges 12.

Once in place, the select portions of the receptacle 64 is still exposed as shown in FIG. 10B. First, a finger pocket 82 along an upper surface 66 of the receptacle 64 is exposed. The finger pocket 82 is a portion of the receptacle 64 extending between the top wall 20 of the dispensing cartridge 12 and the upper surface 66 of the receptacle 64. The finger pocket 82 is sized and shaped to allow a finger or thumb to insert into the receptacle 64 and grasp the dispensing cartridge 12. Further, a depression 74 in the rear wall 70 can be provided to allow for alternative cartridges to fit within the receptacle 64.

Further, a water pocket 84 along a bottom surface 68 of the receptacle 64 is exposed. The water pocket 84 is a portion of the receptacle 64 extending between the plurality of openings 42 and the bottom surface 68. Water from the spa generally fills the space within the water pocket 84. In some cases, the water line in the main seating area of the spa is higher than the plurality of openings 42. This ensures that the water pocket 84 is continuously filled with water.

The cartridge 12 is positioned such that the plurality of openings 42 is sufficiently spaced from the bottom surface 68 to provide a sufficient water pocket 84. The water pocket 84 is generally protected from turbulent flow of water because it is enclosed by the bottom surface 68, the rear surface 70 and the side surfaces 72 of the receptacle 64. At the same time, enough water is within the water pocket 84 to move dispersants out of the openings 42.

The water pocket 84 is in fluid communication with water from the spa. In certain cases, the water pocket 84 is in fluid communication with water in the main seating area of the spa. For example, the water pocket 84 can be in direct communication with water in the main seating area or in pervious communication.

In other cases, the water pocket 84 is not in fluid communication with a recirculation water flow path. The term “recirculating water flow path” refers to any path of water that is recirculating back to the main seating area through a circulation system. In specific cases, the water pocket 84 is not directly within a recirculating water flow path through a filter.

In some cases, the cartridge holder 10 is integrated as part of a spa. For example, the cartridge holder 10 can be integral to a component of the spa, such as an upright spa sidewall. The spa sidewall can be any upright sidewall of a spa that is exposed to less turbulent water but not exposed to a moving water flow path. In some cases, the upright spa sidewall is a sidewall of the spa shell that is exposed to water in a main seating area. In other cases, the upright spa sidewall is a sidewall of the spa shell that is behind a removable structure of the spa, such as a removable seat or removable jet module. In certain cases, the removable seat or removable jet module does not provide a watertight seal between the sidewall behind and water from the main seating area.

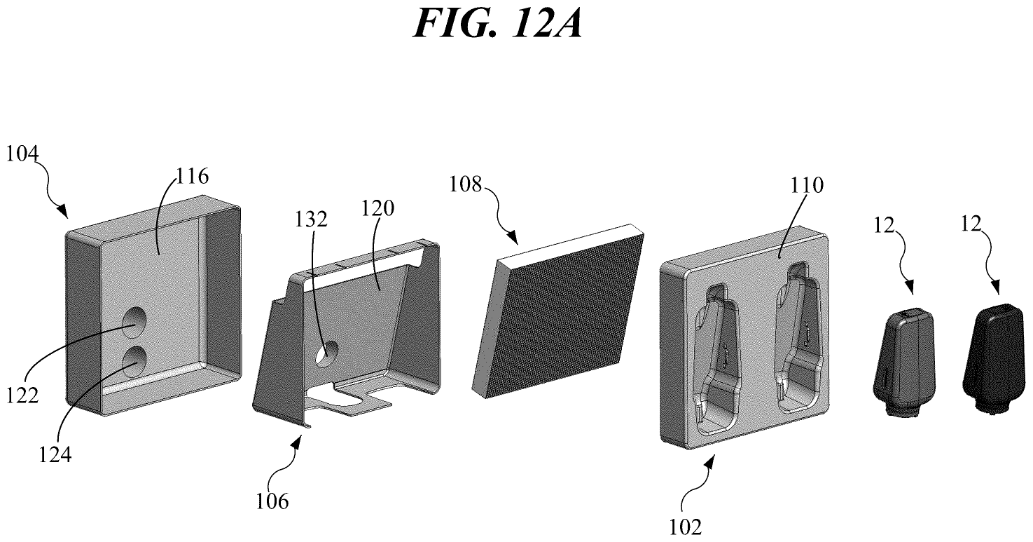

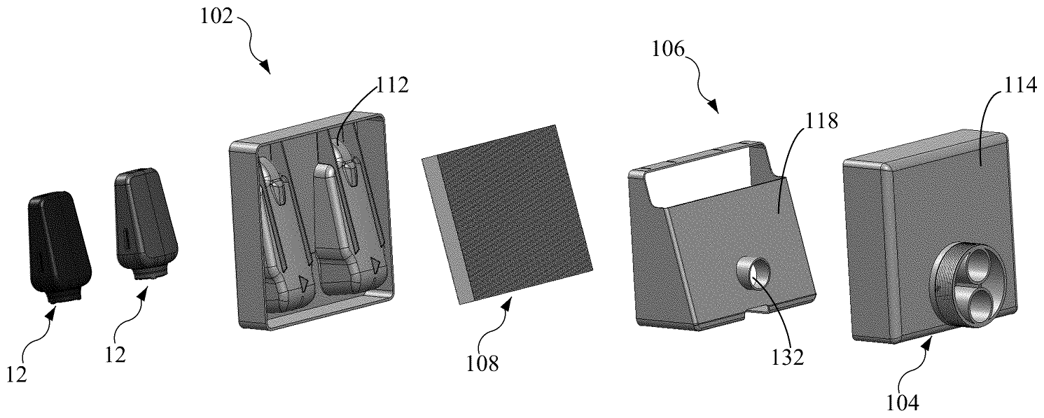

FIGS. 12A and 12B illustrate the filter housing 100 in exploded configurations. As discussed with reference to FIG. 9, the filter housing 100 is provided within a spa filter line that includes the water flow path. The filter housing 100 includes the front component 102 and the rear component 104 that fit together to house the frame 106 and the filter 108. The front component 102 includes the outer surface 110 and the inner surface 112. Likewise, the rear component 104 includes the outer surface 114 and the inner surface 116. Further, the frame 106 includes the outer surface 118 and the inner surface 120. As used herein, the term “outer surface” refers to a surface any component that faces away from the filter 108 housed inside. Likewise, the term “inner surface” refers to a surface that faces the filter 108 housed inside.

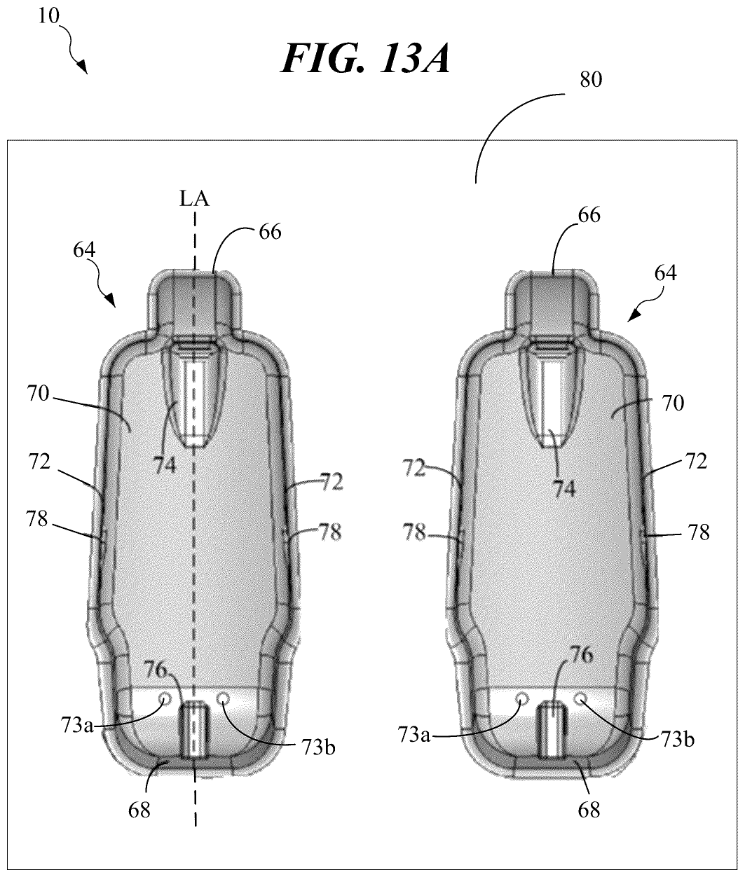

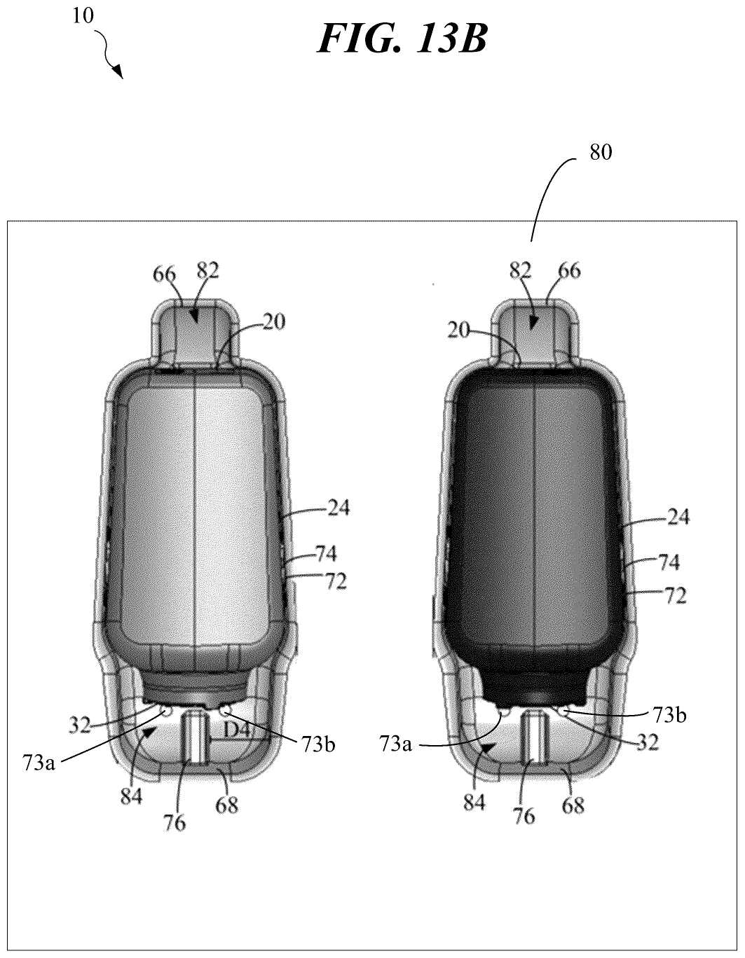

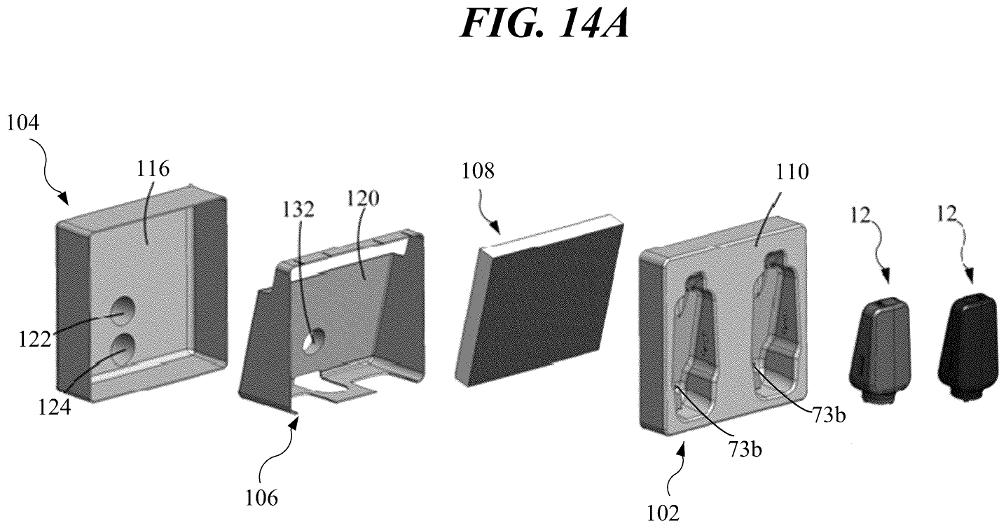

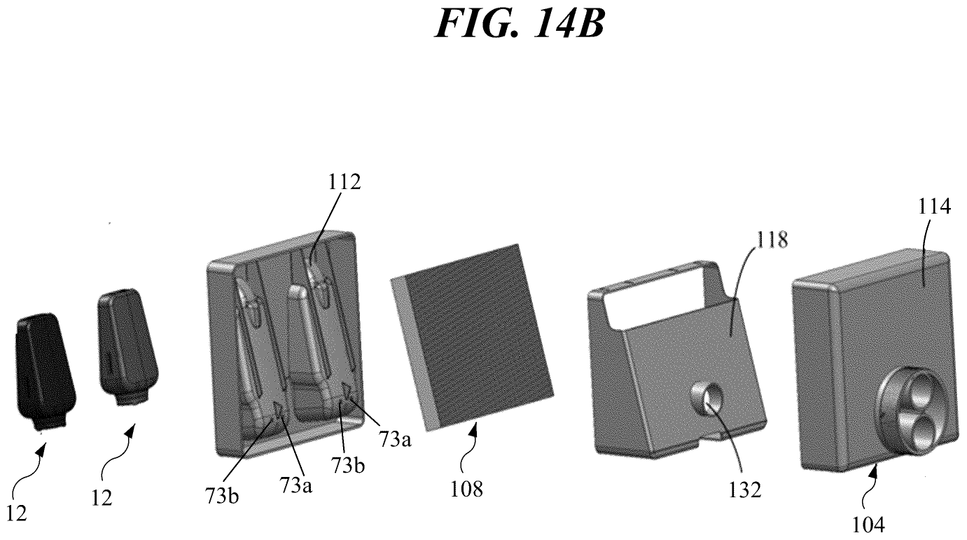

FIG. 13A illustrates a front view of the cartridge holder 10 with two receptacles 64, FIG. 13B illustrates a front view of the cartridge holder 10 receiving two dispensing cartridges 12 within two receptacles 64, and FIGS. 14A and 14B illustrate the filter housing 100 in exploded configurations. The cartridge holder 10 and the filter housing 100 shown in FIGS. 13A to 14B is like the cartridge holder 10 shown in FIGS. 10A and 10B and the filter housing 100 shown in FIGS. 12A and 12B, but the cartridge holder 10 shown in FIGS. 13A to 14B includes one or more passages 73a, 73b positioned within the one or more receptacles 64. The one or more passages 73a, 73b may be positioned into some of the one or more recirculating water flow paths. The one or more passages 73a, 73b may permit water flow by permitting water flow between some of the one or more recirculating water flow paths and the one or more receptacles 64. In some examples, the one or more passages may permit water to be sucked from the one or more receptacles into some of the one or more recirculating water flow paths. The one or more passages 73a, 73b may be located in the one or more water pockets along a lower surface of the one or more receptacles below the plurality of openings. The water pockets are therefore below the water line, which is above the plurality of openings. The water pockets 84 protecting the plurality of openings from turbulent flow of spa water. Since the one or more passages 73a, 73b lead to the one or more recirculating water flow paths, which, in this case, is the flow path inside the filter housing 100, the one or more passages 73a, 73b increase the water flow proximate the plurality of openings. The increased water flow proximate the plurality of openings will naturally lead to increased levels of the dispersant being introduced into the water. In addition, since the flow through the one or more passages 73a, 73b may be a suction flow into the one or more recirculating water flow paths, a portion of the dispersant coming from the plurality of openings may be introduced into the one or more recirculating water flow paths, the dispersant will have wider distribution throughout the spa tub.

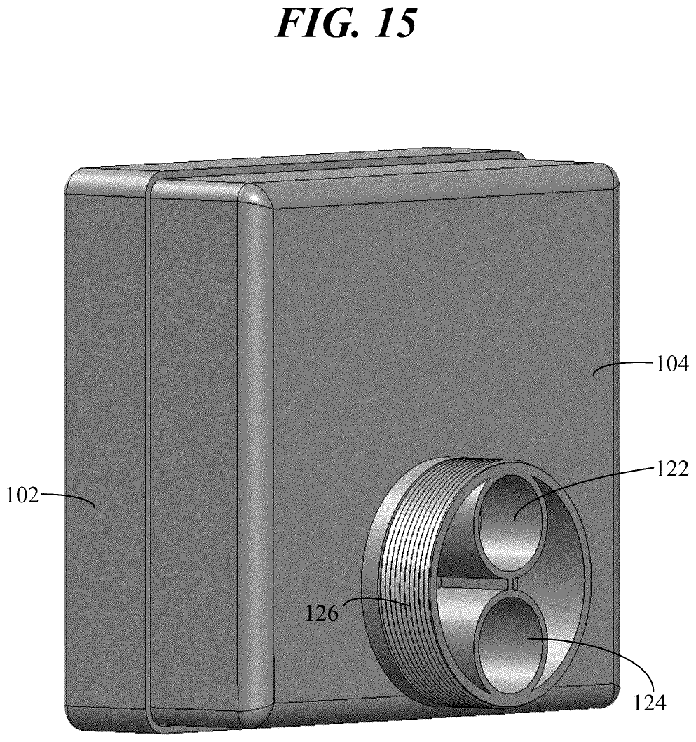

Referring to FIG. 15, the rear component 104 includes a water inlet port 122 and a water outlet port 124. The water inlet port 122 extends from the outer surface 114 to the inner surface 116 so that water flows into the inside of the housing 104. Similarly, the water outlet port 124 extends from inner surface 116 to the outer surface 114 so that water flows out of the housing 104. The rear component also includes a connector 126. In many cases, both the water inlet port 122 and water outlet port 124 are provided within the connector 126. The connector 126 can be any structure that connects the inlet port 122 and the outlet port 124 to a water flow line. In some cases, the connector 126 is a threaded boss.

The frame 106 also includes an inlet port hole 132 that extends from the inner surface 116 to the outer surface 118. When the frame 106 is connected to the inner surface 116, the inlet port hole 132 aligns with the inlet port 122. Thus, water entering the housing through the inlet port 122 also passes through the frame 106 via the inlet port hole 132.

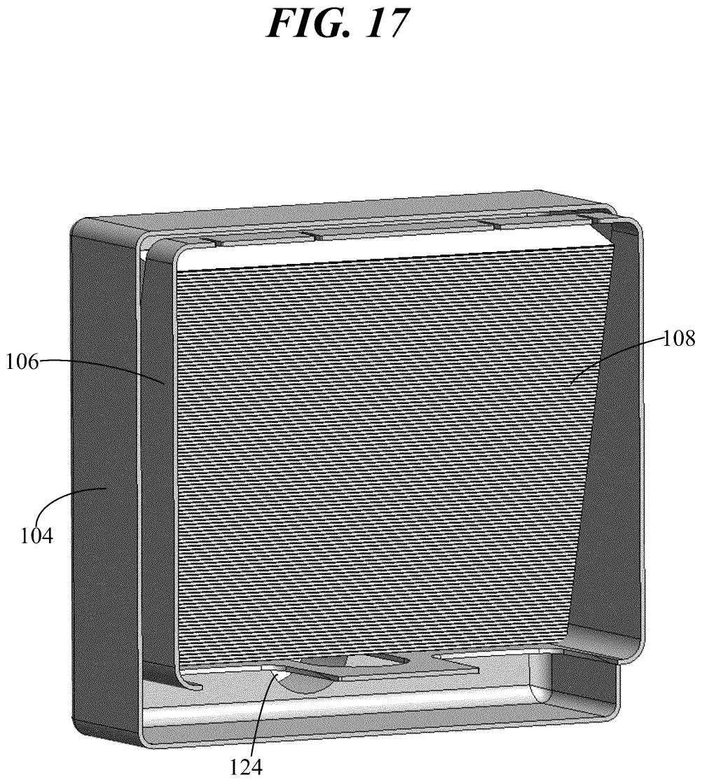

The filter 108 is received by one or more surfaces of the inner surface 120 of the frame 106 as shown in FIG. 17. The filter 108 can be a planar filter, such as a planar quadrilateral filter. In the illustrated embodiment, the filter 108 is a planar square filter. The frame 106 can include one or more surfaces that support such a filter. Skilled artisans will understand that a variety of other filter shapes can also be used.

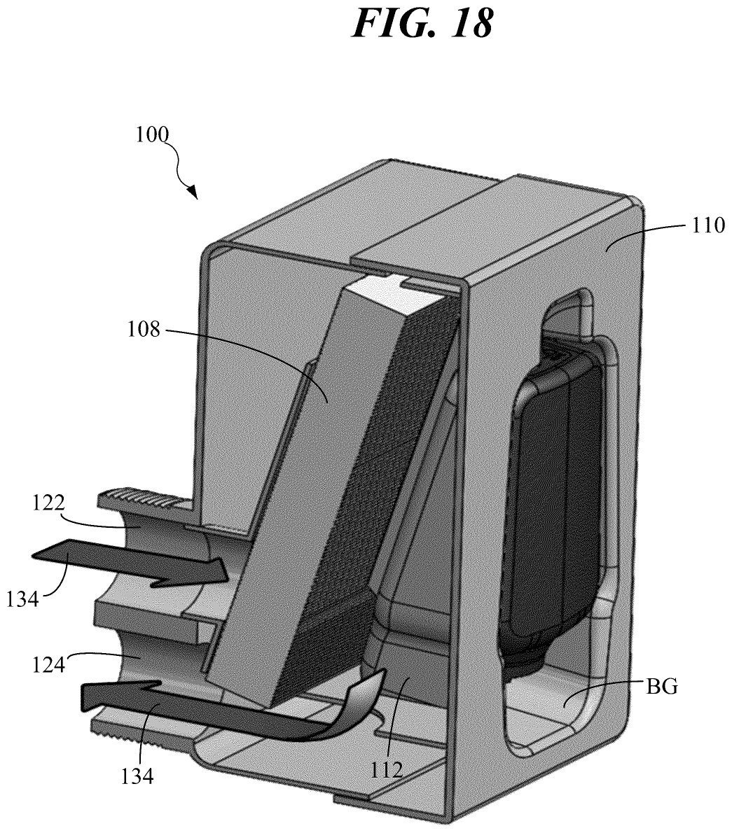

FIG. 18 illustrates a general water flow path 134 through the filter housing 100. Water moves into the filter housing 100 via the inlet port 122. The water moves through the filter 108 and then exits the housing through the outlet port 124. The inlet port 122 can be in communication with an inlet or drain to receive water from the main seating area. The outlet port 124 can be in communication with an outlet leading back to the main seating area. Generally, the water moves along the water flow path 134 at a flow rate. The water can be moved along the water flow path via any water flow mechanism. In some cases, water is pulled through the outlet port 124 via downstream pumps. As a result, the water has turbulence and spiraling as it moves through the filter housing 100.

Rather than providing the cartridge holder 10 (and thus dispensing cartridges 12) within the water flow path of the filter housing 100, where dispersants would be dispensed at a faster rate, the cartridge holder 10 is provided on the outer surface 110. The water pocket 84 of the receptacles is in fluid communication with water that is not part of the water flow path 134.

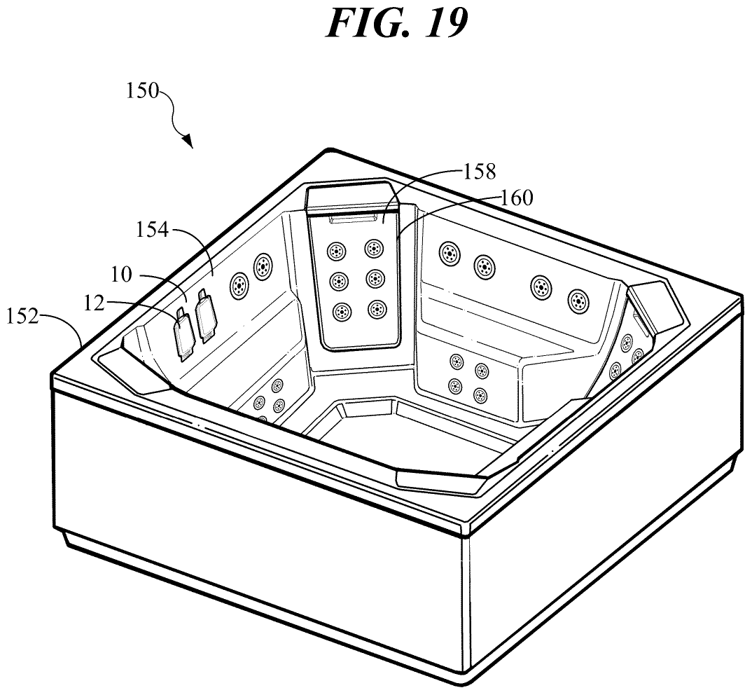

FIGS. 19-21 illustrate a spa 150 having a spa shell 152. The spa shell 152 includes a plurality of sidewalls 154 that form a main seating area. Certain sidewalls 154 can be sidewalls directly exposed to water in the main seating area. Other sidewalls 154 can be sidewalls in the main seating area that are covered by pervious panels. Other sidewalls 154 are provided as parts of recesses 156 that are later covered with a removable component 158 such as a removable seats or removable Jetpacks. Such recesses 156 are still exposed to water in the main seating area because the removable components 158 are not installed to be watertight. In many cases, water moves behind the removable component 158 to access the recesses 156 via pervious seams 160. The pervious seams 160 allow water to ingress and egress therethrough.

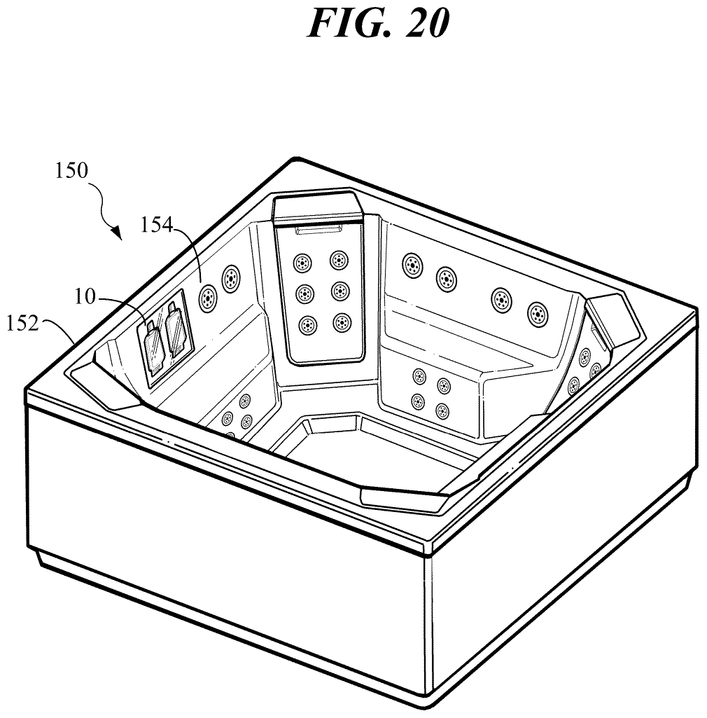

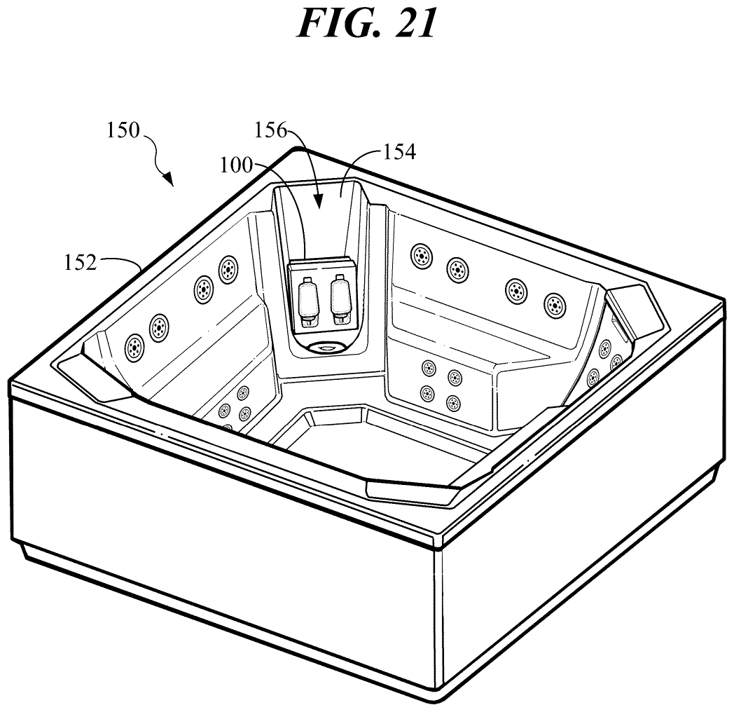

FIG. 19 illustrates a spa 150 having a cartridge holder 10 integral to a spa sidewall 154 that is exposed to a main seating area. FIG. 20 illustrates a spa 150 having a cartridge holder 10 as a separate component that inserts into a spa sidewall 154 that is exposed to a main seating area. In both FIG. 19 and FIG. 20, water from the main seating area is in direct fluid communication with the water pocket 84. The dispensing cartridges 12 dispense dispersants directly into water in the main seating area.

In other embodiments, a pervious panel (not shown) can be placed over the cartridge holder 10 of FIG. 19 or FIG. 20 to hide it from view. The pervious panel can be any structure that is not watertight and allows water from the main seating area to ingress and egress therethrough to access the water pocket 84.

FIG. 21 illustrates a spa 150 having a cartridge holder 10 formed as part of a filter housing 100. The filter housing 100 in turn is received by a recess 156 that forms a seating area. The filter housing 100 is positioned in the recess 156 such that the outer surface 110 of the front component 102 faces the main seating area. The outer surface 114 of the rear component 104 faces the spa sidewall 154 and the connector 126 connects the housing 100 to a filter line. A removable component 158 such as a removable seat or removable Jetpack can then be placed within the recess 156 so that the filter housing is between the sidewall 154 of the recess 156 and the removable component 158. Again, the removable component 158 is not installed to be watertight.

Skilled artisans will understand that the cartridge holder 10 or filter housing 100 can also be provided in other places in the spa so long as the water pockets 84 are in fluid communication with water from the spa.

While some preferred embodiments of the invention have been described, it should be understood that various changes, adaptations and modifications may be made therein without departing from the spirit of the invention and the scope of the appended claims.

What is claimed is:

1. A spa having a water treatment system, comprising:
a spa shell forming a water chamber for containing spa water;
a piping system external to the water chamber that provides one or more recirculating water flow paths, one of the one or more recirculating water flow paths including a filter, the one or more recirculating water flow paths removing spa water from the water chamber and returning the spa water to the water chamber;
one or more receptacles in an upright wall located in the water chamber; and
one or more dispensing cartridges each having a plurality of openings for dispensing a dispersant, each dispersant providing a water treatment function, the one or more dispensing cartridges removably fixed in the one or more receptacles where the plurality of openings are below a water line of the water chamber and in fluid communication with spa water when the water chamber holds spa water, the plurality of openings permitting ingress and egress of spa water into and out of the one or more dispensing cartridges to aid in dispensing the dispersants into the spa water.

2. The spa of claim 1, wherein the upright wall is a spa sidewall integral to the spa shell.

3. The spa of claim 1, wherein the upright wall is in a main seating area of the spa shell.

4. The spa of claim 1, wherein the upright wall is an upright sidewall of the spa shell located behind a removable structure of the spa, the removable structure not being watertight with the upright sidewall of the spa.

5. The spa of claim 4, wherein the removable structure is a removable seat or a removable jet module.

6. The spa of claim 1, wherein the spa shell includes a plurality of sidewalls that form a main seating area, some of the plurality of sidewalls being covered by removable components, the removable components not blocking exposure of the some of the plurality of sidewalls to spa water, the one or more receptacles being covered by the removable components.

7. The spa of claim 1, wherein the spa shell includes a plurality of sidewalls that form a main seating area, some of the sidewalls being covered by removable components, seams between the some of the plurality of sidewalls and the removable components being pervious thereby exposing the some of the plurality of sidewalls to spa water, the one or more receptacles being covered by the removable components.

8. The spa of claim 1, wherein the one or more receptacles include one or more water pockets along a lower surface of the one or more receptacles below the plurality of openings, the water pockets filling with spa water with the water line above the plurality of openings, the water pockets protecting the plurality of openings from turbulent flow of spa water.

9. The spa of claim 8, wherein the one or more water pockets are not in fluid communication with the piping system providing the one or more recirculating water flow paths.

10. The spa of claim 1, wherein the one or more receptacles include one or more passages into some of the one or more recirculating water flow paths, the one or more the one or more passages permitting water flow permitting water flow between the some of the one or more recirculating water flow paths and the one or more receptacles.

11. The spa of claim 10, wherein the one or more the one or more passages permitting water to be sucked from the one or more receptacles into the some of the one or more recirculating water flow paths.

12. The spa of claim 1, wherein the one or more receptacles and the one or more dispensing cartridges are configured to create a friction fit to hold the one or more dispensing cartridges within the one or more receptacles.

13. The spa of claim 1, wherein the one or more dispensing cartridges have recesses and the one or more receptacles have protrusions, the recesses being sized and positioned to receive the protrusions in a friction fit to hold the one or more dispensing cartridges in the one or more receptacles when the one or more dispensing cartridges are located in the one or more receptacles.

14. The spa of claim 1, wherein the one or more receptacles include one or more finger pockets along an upper surface of the one or more receptacles above the one or more dispensing cartridges and being sized and shaped to allow a finger or thumb to insert into the one or more finger pockets and dislodge the dispensing cartridges.

15. A spa having a water treatment system, comprising:
a spa shell forming a water chamber for containing spa water;
one or more receptacles in an upright wall located in the water chamber;
one or more dispensing cartridges each having plurality of openings for dispensing a dispersant, each dispersant providing a water treatment function, the one or more dispensing cartridges removably fixed in the one or more receptacles where the plurality of openings are below a water line of the water chamber and in fluid communication with spa water when the water chamber holds spa water, the plurality of openings permitting ingress and egress of spa water into and out of the one or more dispensing cartridges to aid in dispensing the dispersants into the spa water; and
a filter housing having a water inlet port and a water outlet port with a filter in a water flow path therebetween, the one or more receptacles being in the filter housing outside of the water flow path.

16. The spa of claim 15, wherein the filter housing is removable from the spa.

17. The spa of claim 15, wherein the water inlet port receives spa water from the water chamber and the water outlet port outputs spa water to the water chamber.

18. The spa of claim 17, wherein the water inlet port receiving spa water via an inlet or drain and the water outlet port outputting spa water to an outlet leading back to the water chamber.

19. The spa of claim 15, wherein spa water is pulled through the water outlet port via downstream pumps.

20. The spa of claim 15, wherein the flow of spa water through the filter housing is via a recirculating water flow path in a piping system external to the water chamber.

21. The spa of claim 15, wherein the filter housing is covered by removable components.

22. The spa of claim 15, wherein the one or more receptacles include one or more passages into an interior of the filter housing, the one or more passages permitting water flow between the filter housing and the one or more receptacles.

23. The spa of claim 22, wherein the one or more passages permitting water to be sucked from the one or more receptacles into the filter housing.

24. The spa of claim 15, wherein the one or more dispensing cartridges include a vent hole permitting ingress and egress of spa water into and out of the one or more dispensing cartridges to aid in dispensing the dispersants into the spa water.

25. The spa of claim 15, wherein the plurality of openings have variable numbers to adjust the rate of dispensing the dispersant.

26. The spa of claim 25, wherein the variable numbers include an off position, a maximum position, and intermediate positions therebetween.

27. The spa of claim 25, wherein the plurality of openings are formed via caps with a lid and a rotatable disc, the rotatable disc being rotatable to control the number of the plurality of openings.

28. The spa of claim 15, wherein the one or more receptacles are sized and shaped to receive the one or more dispensing cartridges in upright positions with the plurality of openings facing downwards.

29. The spa of claim 28, wherein the one or more dispensing cartridges include two dispensing cartridges and the two dispensing cartridges are positioned side-by-side in the upright wall.

30. The spa of claim 15, wherein each of the one or more dispensing cartridges includes an adapter that adapts the one or more dispensing cartridges to fit within the one or more receptacles.

31. The spa of claim 15, wherein the one or more dispensing cartridges are restricted from removal from within the one or more receptacles.
